(19) United States
(12) Patent Application Publication
(10) Pub. No.: US 2004/0090014 A1
(43) Pub. Date: May 13, 2004

(54) Nuclear low pressure packing casing for rotary machine and casing fabrication method

(76) Inventors: Noel Jacob Bylina, Niskayuna, NY (US); Richard Lloyd Mattice, Broadalbin, NY (US)

Correspondence Address: NIXON & VANDERHYE P.C./G.E., 1100 N. GLEBE RD., SUITE 800, ARLINGTON, VA, 22201, US

(21) Appl. No.: 10/291,654

(22) Filed: Nov. 12, 2002

(51) Int. Cl. F16J 15/18; F16J 15/26

(52) U.S. Cl. 277/510

(57) ABSTRACT

A nuclear low pressure packing casing having reduced horizontal joint leakage. This is accomplished by providing packing ring carriers that are separately formed from the casing so that thermal distortion loads will not be transmitted to the horizontal joints. In an embodiment of the invention, the packing ring carriers are fit in place in pre-machine grooves in the casing rather than being welded directly to the casing. According to further, optional feature of the invention, the vent or seal steam enters or exits at only one of the bottom quadrants rather than the entire bottom half so that the packing case design can be simplified to reduce fabrication and material costs.

### BACKGROUND OF THE INVENTION

The present invention relates to seals between rotating and stationary components of rotary machines. More particularly, the present invention relates to a nuclear low pressure steam turbine packing casing design that is less prone to leakage by reducing horizontal joint distortion.

In rotary machines, such as turbines, seals are provided between rotating and stationary components. More particularly, typically, arcuate packing ring segments (arcuate seal segments) are disposed in an annular groove in the stationary component concentric to the axis of rotation of the machine and thus concentric to the sealing surface of the rotating component. Each arcuate packing ring segment carries an arcuate seal face in opposition to the sealing surface of the rotating component.

In a typical installation, as shown in FIGS. 2-3, each annular groove 10, 12 is dovetail shaped having locating flanges directed axially toward one another and defining a slot therebetween. The stationary component (casing) is typically split lengthwise along a generally horizontally extending mid-line defining upper and lower halves 16, 18 of the stationary housing. Thus, semi-annular dovetail grooves 10, 12 receive portions of the arcuate packing ring segments. The packing ring segments are similarly dovetail-shaped having a pair of flanges directed axially away from one another for disposition within the dovetail groove and the neck which joins the seal face and flanges of the segment passes through the slot defined by the locating flanges of the groove. The conventional packing ring segments are omitted from the illustrations for clarity and ease of illustration of the packing carriers. Similarly, the rotor structure is omitted for clarify but its axis of rotation is depicted in FIG. 1.

Conventional nuclear low pressure steam turbine packing casings 16, 18 are normally fabricated from cut and formed steel plates that are welded together. This fabrication is machined as an assembly for the bore diameters that locate the packing ring carriers 20, 22. The packing ring carriers are then welded to the packing casing fabrication. Such nuclear low pressure steam turbine packing casings 16, 18 are susceptible to air in leakage which will adversely affect performance. More particularly, because the traditional packing casing is fabricated from plate material welded together, all movements of the packing are directly transmitted into the horizontal joints 24, 26. There are thermal gradients across each packing stage and this uneven thermal distortion is thus directly passed into the horizontal joints. Over time, the packing casing horizontal joints will distort due to the thermal gradients across each packing. Once the joint starts to open, steam can leak through and erode a through passage for air to leak in.

### BRIEF DESCRIPTION OF THE INVENTION

The present invention provides a nuclear low pressure packing casing that has reduced horizontal joint leakage. This is accomplished by providing packing ring carriers that are separately formed from the casing so that thermal distortion loads will not be transmitted to the horizontal joints. In an embodiment of the invention, the packing ring carriers are fit in place in pre-machine grooves in the casing rather than being welded directly to the casing.

Thus, the invention may be embodied in a packing casing for a rotary machine having a component rotatable about an axis, comprising: an upper casing half; a lower casing half; and a plurality of packing carriers each said packing carrier comprising a part circumferential segment having an inner circumferential surface and an outer circumferential surface; each said segment including a dovetail slot defined in said inner circumferential surface thereof for receiving a complimentarily configured packing ring, said packing carriers being disposed about a circumferential inner periphery of said casing halves, and said packing carriers being substantially free from fixed attachment to said casing halves.

The invention may also be embodied in a packing casing for a rotary machine having a component rotatable about an axis, comprising: an upper casing half and a lower casing half, each of said upper and lower casing halves having a plurality of grooves defined along a circumferential inner periphery thereof; and a plurality of packing carriers each said packing carrier comprising a part circumferential segment having an inner circumferential surface, a dovetail slot defined in said inner circumferential surface for receiving a complimentarily configured packing ring, an outer circumferential surface, and a radial flange projecting radially from said outer circumferential surface, said radial flanges being sized and configured for disposition in respective grooves of said casing halves.

A method of fabricating a packing carrier embodying the invention is also provided. Thus, the invention is further embodied in a method of fabricating a packing casing for a rotary machine having a component rotatable about an axis, comprising: providing a plurality of packing carriers, each as a finished machined part, each said packing carrier being a part circumferential segment having an inner circumferential surface, a dovetail slot defined in said inner circumferential surface for receiving a complimentarily configured packing ring, an outer circumferential surface, and a radial flange projecting radially from said outer circumferential surface; cutting, forming and welding steel plates to produce upper and lower casing fabrications; machining said upper and lower casing fabrications to a bore diameter for locating the packing ring carriers therein, thereby to produce upper and lower casing halves; and at least one of forming and machining a plurality of circumferential grooves along a circumferential inner periphery of each said upper and lower casing halves, said grooves being sized and configured for receiving respective flanges of said packing carriers.

According to a further feature of the invention, a simplified arrangement of vent and seal steam passages are provided to reduce fabrication costs. According to this embodiment, the vent or seal steam enters or exits at only one of the bottom quadrants rather than the entire bottom half so that the packing case design can be simplified to reduce fabrication and material costs.

An advantage of the simplified steam passage design is that the upper half of the packing casing becomes much simpler and less expensive to fabricate because it is basically a shell for holding the packing carriers.

### BRIEF DESCRIPTION OF THE DRAWINGS

These and other objects and advantages of this invention, will be more completely understood and appreciated by careful study of the following more detailed description of the presently preferred exemplary embodiments of the invention taken in conjunction with the accompanying drawings, in which:

FIG. 1 is a schematic perspective view of a conventional packing casing;

FIG. 2 is a schematic cross-sectional view of the packing casing shown in FIG. 1;

FIG. 3 is a schematic perspective view of the packing casing lower half showing the conventional horizontal joint;

FIG. 4 is a schematic perspective view similar to FIG. 1, but illustrating a packing casing according to a first embodiment of the invention;

FIG. 5 is a schematic cross-sectional view of the packing casing configuration shown in FIG. 4;

FIG. 6 is a schematic plan view of the packing casing bottom half according to the embodiment of FIGS. 4-5;

FIG. 7 is an enlarged, partial, schematic perspective view of a packing casing upper half embodying the invention; and

FIG. 8 is a schematic elevational view of a packing casing lower half according to a second embodiment of the invention.

### DETAILED DESCRIPTION OF THE INVENTION

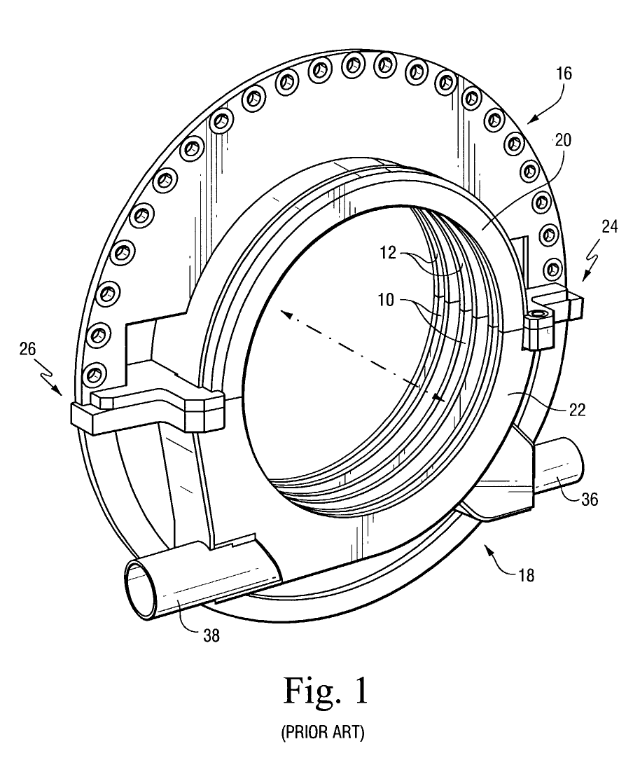

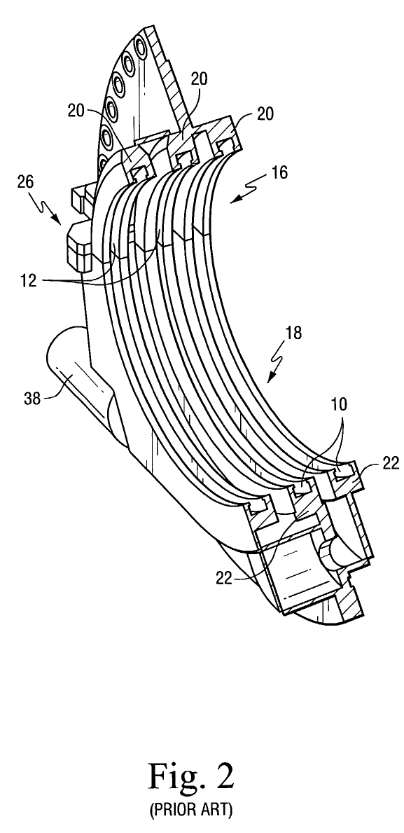

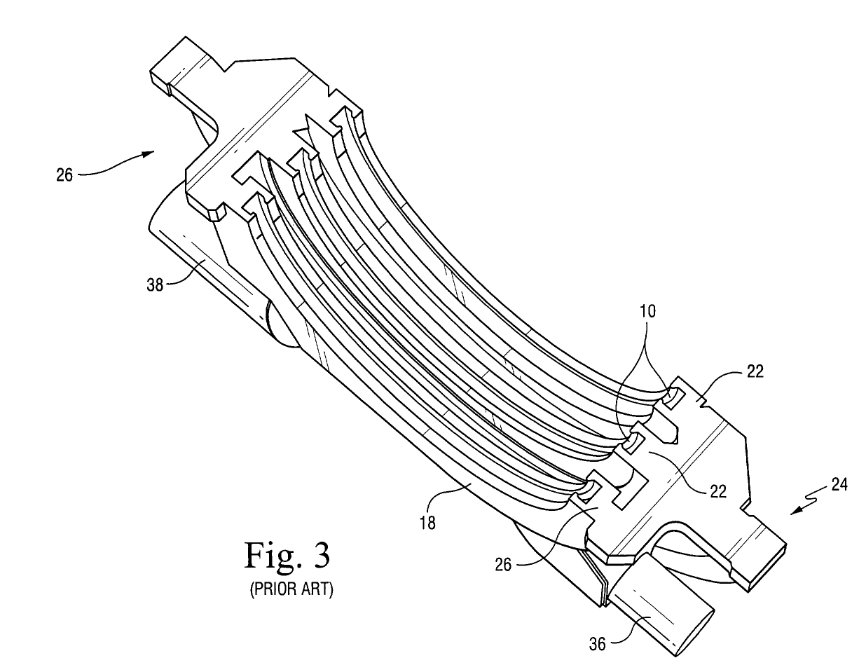

FIGS. 1-3 illustrate a conventional packing casing design. As noted above, conventional packing casings are fabricated from cut and formed steel plates that are welded together. This fabrication is then machined as an assembly for the bore diameters that locate the carriers. The packing ring carriers 20, 22 are welded to the packing casing 16, 18, respectively, as illustrated in particular in FIGS. 2 and 3.

As mentioned above, because the traditional packing casing is fabricated as plate material welded together and because the packing ring carriers are welded to the packing casing, all movements of the packing are transmitted into the horizontal joint. The invention proposes to reduce horizontal joint leakage by separately providing the packing ring carriers from the casing so that thermal distortion loads will not be transmitted to the horizontal joint.

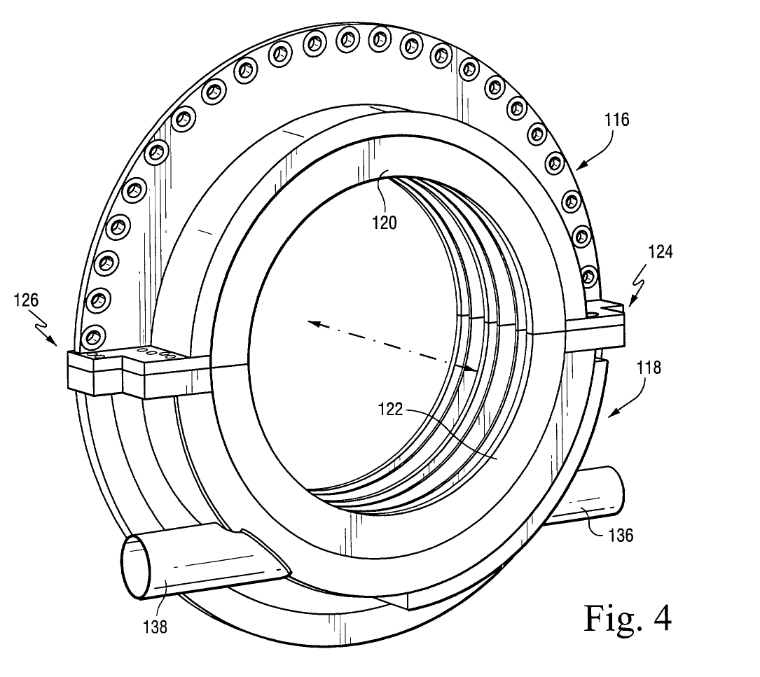

A nuclear low pressure packing casing provided as a first embodiment of the invention is illustrated by way of example in FIGS. 4-7. For ease of explanation and understanding, components of this packing casing that generally correspond to components of the above-described conventional packing casing are designated with corresponding reference numbers, incremented by 100, but the description thereof is limited to that required to call out the differences between the inventive configuration and the conventional assembly.

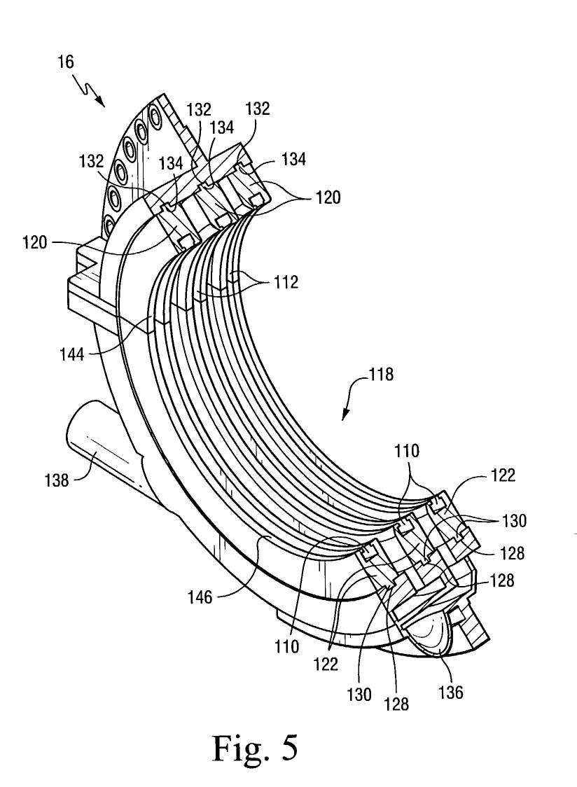

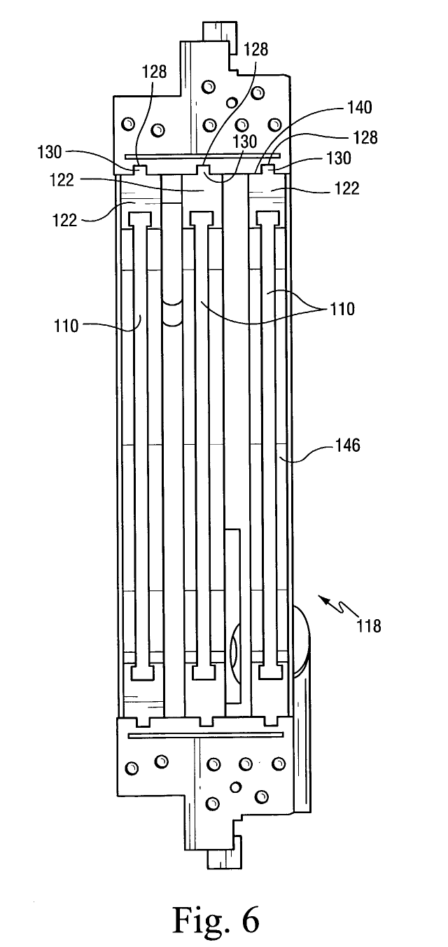

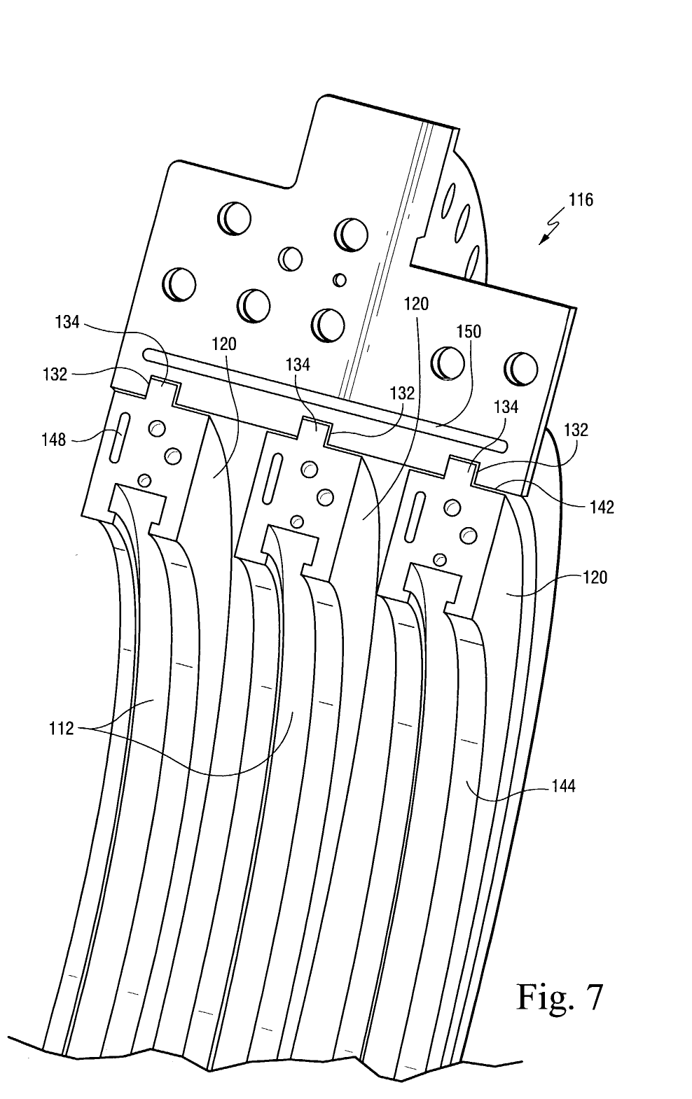

As illustrated in FIGS. 5-7, the packing ring carriers 120, 122 are fit in place in pre-machined grooves 132, 128 in the casing halves 116, 118, respectively, rather than being welded directly to the casing halves. Thus, in the embodiment illustrated in FIGS. 5 and 6, the lower casing half 118 is machined to define grooves or slots 128 for receiving correspondingly sized and shaped flanges or tongues 130 projecting radially from the outer circumferential surfaces 140 of the packing carriers 122. FIGS. 5 and 7 also illustrate the upper half packing casing 116 having slots or grooves 132 for receiving the flanges or tongues 134 projecting radially outwardly from the outer circumferential surfaces 142 of the packing carriers 120. As illustrated in FIGS. 4-7 the inner circumferential surfaces 144, 146 of the packing carriers 120, 122 are conventionally configured to have dovetail grooves 110, 112 for receiving conventional packing rings (not shown).

The packing ring carriers are thus provided as separate ring portions 120, 122, each defining a finished machined part. Though the packing carriers have flanges or keys 128, 130 seated in respective grooves, they are not fixedly secured to the remainder of the casing halves 116, 118. Accordingly, thermal distortion loads will not be transmitted to the horizontal joints, and the likelihood of horizontal joint distortion over time is reduced.

The packing carrier upper halves 120 are installed in the upper half packing casing and then the entire upper half with carriers is attached to the lower half. The packing carriers 120 are each held in their position by retaining key(s) (not shown). Dowels on each side of the packing carrier controls the fit between the upper and lower halves and sealing keys 148 minimize leakage across the individual carrier. Circumferential sealing is further provided at the surface between the carrier and the casing, more specifically at the interface of the tongue 134 and groove 132, as shown in FIG. 7. The surfaces are forced to mate together by a differential pressure across the packing carrier. Part of the surface is machined to a tight tolerance on both the carrier and the casing so that when they contact a seal is formed.

In the illustrated embodiment, the horizontal joint width is increased so that seal keys 150 can be provided to minimize leakage. Furthermore, bolting can be improved by using three bolts instead of screws and a fitted bolt can be used instead of a dowel for locating the respective halves of the horizontal joint. Adding seal keys helps to reduce leakage across the joint by interrupting the smooth surface and providing a blockage to the flow. By using bolts instead of screws, higher preloads are possible to obtain which can keep the flange surfaces together better. Again minimizing leakage potential. Also, by using a fitted bolt instead of a dowel, additional bolt force can be obtained again to keep the joint surfaces together by having higher forces across the joint. The dowel (or fitted bolt) helps align the upper and lower halves together. These are all improvements over past practice.

As will be appreciated and understood, the upper and lower halves of a packing casing embodying the invention may be fabricated in a generally conventional manner by cutting, forming and welding steel plates to produce upper and lower casing fabrications. If necessary or desirable, the upper and lower casing fabrications are then machined to a bore diameter for locating the packing ring carriers therein, thereby to produce upper and lower casing halves.

The circumferential grooves for engaging the flanges of the packing carriers are formed and/or machined along a circumferential inner periphery of each of the upper and lower casing halves. To complete the fabrication process, a plurality of packing carriers, each provided as a finished machined part are disposed about the circumferential inner periphery of the casing halves. As described above, each packing carrier is a part circumferential segment having an inner circumferential surface, a dovetail slot defined in the inner circumferential surface for receiving a complimentarily configured packing ring (not shown), an outer circumferential surface, and a radial flange projecting radially from the outer circumferential surface.

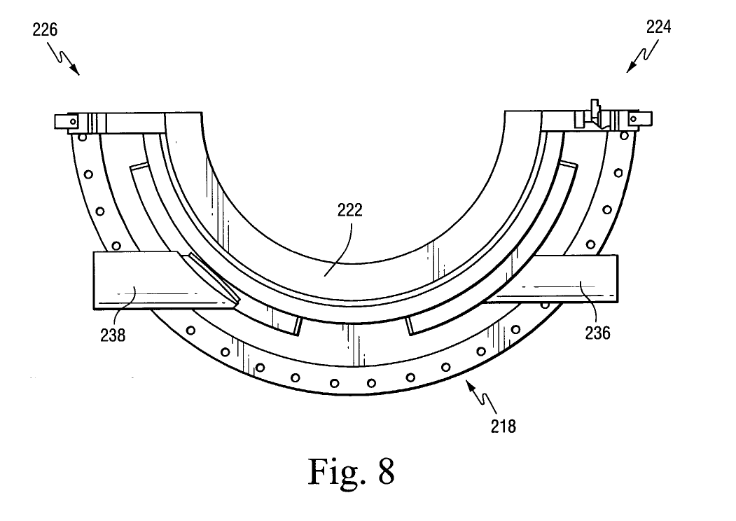

According to a further feature of the invention, the vent and steam seal passages may be simplified as compared to the prior art configuration of FIGS. 1-3. In this regard, as illustrated in FIGS. 4-5, in a first embodiment, the casing includes vent and seal passage ways 136, 138 similar to the vent and seal passage ways 36, 38 of the conventional configuration of FIGS. 1-3. As illustrated in FIG. 8, as a second embodiment of the invention, the passageways 236, 238 for the vent and seal steam may be provided to enter or exit at only one of the bottom quadrants rather than the entire bottom half so that the packing casing can be made easier and less expensively. On advantage of this design is the upper half of the packing casing becomes much simpler and less expensive to fabricate because it is basically a shell to hold the packing carriers. Also, since the steam is entering in only one quadrant, the machining and fabrication is simplified because the steam passageways are not as complex as in the original configuration.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. Thus, while the packing casing illustrated in FIGS. 5-7 has three packing carriers 120, 122, it is to be understood that there may be more carriers depending upon the packing casing design and sealing system.

What is claimed is:

1. A packing casing for a rotary machine having a component rotatable about an axis, comprising:
an upper casing half;
a lower casing half; and
a plurality of packing carriers each said packing carrier comprising a part circumferential segment having an inner circumferential surface and an outer circumferential surface; each said segment including a dovetail slot defined in said inner circumferential surface thereof for receiving a complimentarily configured packing ring, said packing carriers being disposed about a circumferential inner periphery of said casing halves, and said packing carriers being substantially free from fixed attachment to said casing halves.

2. A packing casing as in claim 1,
wherein each of said upper and lower casing halves has a plurality of grooves defined along said inner periphery thereof;
wherein a radial flange projects radially from said outer circumferential surface of each said packing carrier, said radial flanges being sized and configured for disposition in respective grooves of said casing halves.

3. A packing casing as in claim 1, wherein each said packing carrier is generally semi-circularly shaped so as to engage a respective inner circumference of a respective casing half.

4. A packing casing as in claim 3, wherein said upper and lower casing halves are bolted together at a horizontal joint and dowels align circumferentially abutting packing carriers at said horizontal joint.

5. A packing casing as in claim 1, wherein said upper and lower casing halves are bolted together at a horizontal joint, and further comprising an axially extending sealing key disposed to extend between said upper and lower casing halves at said horizontal joint.

6. A packing casing as in claim 1, wherein said lower casing half includes vent and seal steam passageways opening to said inner circumferential surface of said casing.

7. A packing casing as in claim 6, wherein each of said vent and seal steam passageways is limited to a respective quadrant of said lower casing so that said vent and steam passages do not substantially overlap.

8. A packing casing for a rotary machine having a component rotatable about an axis, comprising:
an upper casing half and a lower casing half, each of said upper and lower casing halves having a plurality of grooves defined along a circumferential inner periphery thereof; and
a plurality of packing carriers each said packing carrier comprising a part circumferential segment having an inner circumferential surface, a dovetail slot defined in said inner circumferential surface for receiving a complimentarily configured packing ring, an outer circumferential surface, and a radial flange projecting radially from said outer circumferential surface, said radial flanges being sized and configured for disposition in respective grooves of said casing halves.

9. A packing casing as in claim 8, wherein each said packing carrier is generally semi-circularly shaped so as to engage a respective inner circumference of a respective casing half.

10. A packing casing as in claim 9, wherein said upper and lower casing halves are bolted together at a horizontal joint and wherein dowels align circumferentially abutting packing carriers at said horizontal joint.

11. A packing casing as in claim 10, further comprising a radially extending sealing key disposed to extend between said abutting packing carriers at said horizontal joint.

12. A packing casing as in claim 8, wherein said upper and lower casing halves are bolted together at a horizontal joint, and further comprising an axially extending sealing key disposed to extend between said upper and lower casing halves at said horizontal joint.

13. A packing casing as in claim 8, wherein said lower casing half includes vent and seal steam passageways opening to said inner circumferential surface of said casing.

14. A packing casing as in claim 13, wherein each of said vent and seal steam passageways is limited to a respective quadrant of said lower casing so that said vent and steam passageways do not substantially overlap.

15. A method of fabricating a packing casing for a rotary machine having a component rotatable about an axis, comprising:
providing a plurality of packing carriers, each as a finished machined part, each said packing carrier being a part circumferential segment having an inner circumferential surface, a dovetail slot defined in said inner circumferential surface for receiving a complimentarily configured packing ring, an outer circumferential surface, and a radial flange projecting radially from said outer circumferential surface;
cutting, forming and welding steel plates to produce upper and lower casing fabrications;
machining said upper and lower casing fabrications to a bore diameter for locating the packing ring carriers therein, thereby to produce upper and lower casing halves; and
at least one of forming and machining a plurality of circumferential grooves along a circumferential inner periphery of each said upper and lower casing halves, said grooves being sized and configured for receiving respective flanges of said packing carriers.

16. A method as in claim 15, wherein said step of cutting, forming and welding includes forming vent and seal steam passageways in said lower casing half that open to a circumferential inner surface thereof, and wherein each of said vent and seal steam passageways is limited to a respective quadrant of said lower casing half so that said vent and steam passageways do not substantially overlap.

17. A method as in claim 15, further comprising aligning circumferentially adjacent packing carriers with dowels and bolting said upper and lower casing halves together at a horizontal joint.

18. A method as in claim 17, further comprising providing a radially extending sealing key to extend between said circumferentially adjacent packing carriers.

19. A method as in claim 17, further comprising providing an axially extending sealing key to extend between said bolted carrier halves.
